(19) United States
(12) Patent Application Publication
(10) Pub. No.: US 2012/0064295 A1
(43) Pub. Date: Mar. 15, 2012

(54) LOW CALIPER GLASS MAT AND BINDER SYSTEM FOR SAME

(75) Inventors: Michael W. Klett, Holden, MA (US); Nancy E. Brown, Braintree, MA (US)

(73) Assignee: Saint-Gobain Technical Fabrics America, Inc .

(21) Appl. No.: 12/879,621

(22) Filed: Sep. 10, 2010

(51) Int. Cl. B32B 5/16; C08L 61/24; B32B 5/02; D21H 17/47; D21H 13/40

(52) U.S. Cl. 428/143; 162/164.1; 162/164.6; 162/156; 442/59; 442/177; 525/154; 524/512

(57) ABSTRACT

Cured non-woven fibrous mats, UF-based resinous binders, asphalt coated roofing material and processes for making cured non-woven fibrous mats are provided. A cured non-woven fibrous mat comprising randomly disposed fibers bound together with a resinous adhesive is provided. The mat has a caliper of less than 30 mil, an LOI of less than 18 wt. %, a hot tensile strength of at least about 60 lbs for a sample width of 2.5 inches, and an areal weight of equal to or less than about 1.8 lbs/100 ft².

### FIELD OF THE INVENTION

The present invention relates to low caliper fiber mats useful for roofing and binders for same.

### BACKGROUND OF THE INVENTION

Roofing materials, such as shingles, roll roofing, and commercial roofing, are typically constructed of a glass fiber mat, an asphalt coating on the fibrous mat, and a surface layer of granules embedded in the asphalt coating.

Chopped strand mat, suitable for use in roofing material, generally includes glass fibers because they are of high strength and tend not to shrink during use. The glass fibers are typically formed by attenuating streams of molten glass material from a bushing. An aqueous sizing composition is usually applied to the fibers after they are drawn from the bushing and the wet fibers are then chopped directly into a container. The sizing chemistry is designed to protect the fibers from breakage during subsequent processing and to be compatible with the matrix they are to reinforce. The wet, chopped fibers are then dispersed in a water slurry which contains surfactants, viscosity modifiers, dispersants and other chemical agents. The fibers and slurry are agitated to disperse the fibers prior to depositing the mixture onto a moving screen where most of the water is removed. A polymeric binder is then applied, and the resulting mat is heated to remove the remaining water and cure the binder. A urea-formaldehyde (“UF”) binder is typically utilized for roofing applications due to its low cost, compatibility with asphalt and resulting high strength. Next, asphalt is applied to the mat, such as by spraying the asphalt onto one of both sides of the mat, or by passing the mat through a bath of molten asphalt in order to place a layer of asphalt on both sides of the mat. A protective coating of granules may be applied to the asphalt-coated mat to provide a roofing material, such as a shingle.

Important properties for glass roofing mat include dry tensile strength, hot asphalt tensile strength, hot wet tensile strength, and tear strength. These mechanical properties are useful in determining the asphalt shingle making process and ultimate reinforcing properties in the shingle. Some have experimented with modifying the urea-formaldehyde binder, such as with a latex modifier, with the hope of increasing the tear strength, as well as the hot tensile strength over unmodified urea-formaldehyde resins. See for example, US Pat. Pubs. 2001/0009834 and 2007/0039703 to Lee et al.; and U.S. Pat. Nos. 4,258,098 to Bondoc et al.; 4,917,764 to Lalwani et al.; 5,518,586 to Mirous; 4,588,634 to Pagen et al. and 4,468,430 to Ruede, which are hereby incorporated herein by reference.

Both urea-formaldehyde (UF) resins and blends of UF resin and acrylic or styrene-acrylic latex can be used to make roofing shingles. These binders are designed to withstand the hot asphalt coating during the shingle making process by virtue of the high cross-linked density of the UF based polymers. The acrylic binders are not without their drawbacks however they tend to have low pH and therefore require special stainless steel mixing, piping, application equipment and also require high temperatures to achieve the necessary crosslinking density needed to survive the hot asphalt bath. High cross-linked density UF binders are not without their drawbacks, however. If the binder density (measured by Loss On Ignition or LOI) becomes too high, the resulting mat is stiff and does not easily conform to the sharp radii used in the process of making shingles. On the other hand, low cross-linked density binders are softened by the hot asphalt (about 400° F.) and subsequently result in the mat tearing or breaking in the asphalt coating process leading to machine down time. Because of this process limitation, the latex component is typically at a low level (less than about 20% weight).

Accordingly, there is a present need for mats and binders systems that present a more consistent cross-linked density and mat stiffness for shingle reliability and controlled production processes. There is also a need for a high cross-linked density resin that withstands the hot asphalt bath, but has lower sensitivity to curing conditions than existing UF binders. Moreover, there is a present need for a lower caliper mat for reducing the weight, thickness and cost of chopped glass mats used for roofing applications and the weight and thickness of roofing shingles themselves. A lower caliper mat must meet existing mechanical properties for glass mats, such as dry tensile strength, hot tensile strength, composite tear strength.

### SUMMARY OF THE INVENTION

The present invention provides in a first embodiment a cured non-woven fiber mat comprising randomly disposed fibers bound together with a resinous adhesive, said mat having a caliper of less than about 30 mil, a percent loss on ignition (LOI) of less than 18 wt. %, a hot tensile strength of at least about 60 lbs per 2.5 inch width and an areal weight of no greater than and preferably less than about 1.8 lbs/100 ft².

The present invention modifies the common UF binder system to preferably include a styrene butadiene polymer, such as carboxylated styrene butadiene rubber, and more preferably, styrene butadiene-acrylic acid terpolymer and a high molecular weight latent acid catalyst/crosslinking polymer. The addition of these and/or similar ingredients to the UF based binder results in a lower caliper glass mat having glass mat and composite (shingle) properties comparable to standard UF binder glass mats, but at a lower LOT.

The preferred mats of this invention can achieve a low caliper of less than 30 mil, and low LOI of about 15-18 wt. % in a mat weighing less than about 1.8 lb/100 ft.², said mat having a dry tensile strength of greater than about 60 lbs per 2.5 inch width, and a hot asphalt tensile strength of greater than about 60 lbs. Said preferred mat and binder has a lower storage modulus equilibration temperature and an overall lower storage modulus than that for an equivalent mat made instead with a 95%-100% UF resin. The preferred mat has a storage modulus plateau of about 155-165° C., preferably about 160° C.

The most preferred UF binder blend includes a high molecular weight latent acid catalyst/crosslinking polymer additive comprising an ammonia-neutralized carboxylated acrylate copolymer, preferably ethylacrylate, butalacrylate, and methalacrylate acid, sold commercially as Viscolex HB-30, which additive preferably has a molecular weight of greater than about 50,000 to about 2,000,000,000 and preferably from 100,000 to about 1,000,000, and a relatively high acid content in order to increase viscosity and act as an efficient latent acid catalyst. This preferred latex binder formula resinous component tends to have a high Tg of greater than 50° C. and contains a high carboxylate functionality.

In another embodiment of the present invention, a cured non-woven fiber mat is provided including by weight, about 60 to about 95 wt. % fibers fixedly bonded with a binder comprising about 5 to about 40 wt. % of a formaldehyde type binder, said binder containing on a solids basis: about 50 to about 71 wt. % urea-formaldehyde (UF) resin; about 25 to about 50 wt. % rubber; and about 0.05 to about 4 wt. % of a latent acid polymeric catalyst/crosslinking polymer.

In the more preferred embodiments, the fibers comprise glass fibers and the polymer additive comprises a latent polymeric cross-linking agent, that also may simultaneously act as a polymeric viscosity modifying agent. The rubber can comprise a natural or synthetic rubber, with carboxylated styrene butadiene rubber (XSBR) being preferred, especially the synthetic rubber variety known as styrene butadiene acrylic acid terpolymer.

In a further embodiment of the present invention, a process for making a cured non-woven fiber mat is provided, which comprises pairing an aqueous slurry of fibers and removing excess water to form a non-woven fibrous web; applying a binder to said non-woven fibrous web, said binder comprising by weight on a solids basis: about 50 to about 75 wt. % urea-formaldehyde (UF) resin; about 25 to about 50 wt. % rubber; and about 0.05 to about 4 wt. % of a latent acid polymeric catalyst/crosslinking agent; and drying or curing said fibrous web.

In still a further embodiment of the present invention, an asphalt coated roofing material is provided which comprises a mat, including randomly disposed fibers bound together with a resinous adhesive, said mat having a caliper of less than about 30 mil, an LOI of less than 18 wt. %, a hot tensile strength of at least about 60 lbs for a 2.5 inch wide sample, and an areal weight of less than about 1.8 lbs/100 ft². This roofing material further includes an asphalt coating applied to the mat wherein the asphalt coating impregnates the mat with an asphalt composition, and a protective coating of granules applied to at least one surface of the asphalt coated mat.

### BRIEF DESCRIPTION OF THE DRAWINGS

The accompanying drawings illustrate preferred embodiments of the invention, as well as other information pertinent to the disclosure, in which:

FIG. 1 is a graph depicting storage modulus (G′)(Pa) v. temperature (° C.) for three binder chemistries;

FIG. 2 is a graph showing caliper for three binders;

FIG. 3 is a graph showing dry tensile strength for three binders;

FIG. 4 is a graph showing LOI for the three binder of FIGS. 2 and 3;

FIG. 5 is a graph showing hot tensile strength vs. LOI for three binders; chemistries;

FIG. 6 is a graph showing hot tensile strength for five binders-optional; and

FIG. 7 is a graph showing tear properties for 4 binders.

### DETAILED DESCRIPTION

Fiber mats useful in making asphalt-coated glass mat shingles often use urea-formaldehyde (“UF”) resins which have been modified with cross-linkers and various catalyst systems, or fortified with latex to achieve desirable mechanical properties. However, such mats have stubbornly been within the caliper range of about 33.4-34.5 mils for mats having a standard weight of about 1.8 lb/100 ft² or less. The present invention was designed to present a lower caliper mat, desirably less than about 30 mil, which is not only thinner, but absorbs less asphalt between the top and lower planar surfaces. This results in a tremendous cost savings in the product, and lower weight, but with the equivalent mechanical properties of thicker mats.

While an asphalt coating is still required on the top and lower layers of asphalt shingles so that a protective coating of granules applied to these surfaces does not accidently contact and damage the glass fiber, the resulting asphalt content of shingles prepared with the inventive mats is lower. While prior art UF binder systems presented mats with high mechanical properties, they tended to be stiff and brittle due to the high degree of cross linking. Adding high amounts of latex greatly improved the flexibility, but resulted in loss of mechanical properties, especially lower thermal resistance to hot asphalt (410° F. or greater) (see for example formulation F in Table 1). The use of the rubber compositions of the present invention, including specially formulated carboxylated styrene butadiene rubber (XSBR), in combination with a latent acid polymeric catalyst/crosslinking agent presents a glass mat with more hot asphalt resistance when cured, even at latex concentrations greater than 20 wt. %. This is achieved with a lower LOI of approximately 18 wt. % or less versus 20 wt. % typical of glass mats made with commercial UF resins.

The process of forming a glass fiber mat in accordance with the present invention begins with chopped bundles of glass fibers of suitable length and diameter. While reference is made using chopper bundles of glass fibers, other forms of glass fibers, such as continuous strands, may also be used. Generally, fibers having a length of about 1.25-3 inches and a diameter of about 3-20 microns are used. Each bundle may contain about 20-300 or more, of such fibers. The glass fiber bundles are added to a dispersant medium to form an aqueous slurry, know in the art as “white water”. The white water typically contains about 0.5% glass, dispersant(s), viscosity modifier(s), foam control and biocide additives. The fibrous slurry is then agitated to form a workable, uniform dispersion of glass fiber having a suitable consistency. The dispersant may contain polyacrylamide, hydroxyethyl cellulose, and other additive such as surfactants, lubricants, defoamers and the like.

The fiber and white water dispersion is then passed onto a mat-forming machine containing a mat forming screen. The dispersion is usually diluted with water to a lower fiber concentration prior to being dispersed on a screen. The fibers are collected at the screen in the form of a wet fiber mat, and the excess water is removed by gravity or, more preferably, by vacuum in a conventional manner, such as by vacuum boxes.

The binder composition is traditionally applied to the gravity- or vacuum-assisted de-watered white glass mat. Application of the binder composition may be accomplished by any conventional means, such as by soaking the mat in an excess of binder solution, or by coating the mat surface by means of a binder applicator such as a sprayer or roll.

Many urea-formaldehyde resins which may be used in the practice of the invention are commercially available. Urea-formaldehyde, such as the type sold by Georgia Pacific Corp. for glass mat application, and those sold by Borden Chemical Co. (now called Hexion) may be used. These resins are generally modified by methylol groups, which upon curing, form methylene or ether linkages. Urea-formaldehyde resins useful in the practice of the invention generally contain 45-65%, preferably about 50-60% non-volatiles, having a viscosity of about 50-500 cps, preferably about 150-300 cps, a pH of 7.0-9.0, preferably about 7.5-8.5. A preferred modified urea-formaldehyde binder is G39 by Georgia Pacific.

Some rubber compositions useful in binder compositions for this invention include carboxylated styrene butadiene (XSBR) and styrene butadiene (SBR) usually provided in the form of a latex. See Farber, “Rubber Types and Structures”, Customs Laboratory Bulletin, Vol. 9, No. 1 (December 1997), hereby incorporated herein by reference. XSBR generally accepts a higher loading of filler with high shear mixing, while still having better colloidal stability. This is because in the case of SBR, the colloidal stability is achieved mainly from the surfactants or stabilizers used in the polymerization, whereas in the case of XSBR, the stabilizers are formed as integral parts of the polymer through the ionization of the carboxylic groups during polymerization which, therefore, offer more permanent colloidal stability. As a result, XSBR can maintain compound viscosity over a wider range of mixing speed and shear rates, and potentially provide sufficient tensile strength without having to be vulcanized or cross-linked with external (additional) crosslinking additives. It also can provide increased polarity through carboxylation by improving the adhesion to many substrates, while proving the resistance to solvents, heat and UV light.

Typical chemicals for carboxylation are the various carboxylic acids, which include acrylic, methacrylic, crotonic, fumaric, etc. These chemicals can be used on their own, or in combination with others. Usually, the level of carboxylation is from about 1 to about 10%. The most preferred rubber for the binder composition is ammonia-neutralized styrene butadiene acrylic acid terpolymer, sold under the brand name Omnabond XL3460 by Omnova.

The present invention also includes latent polymeric acid catalyst/crosslinking agent. Such polymer additives, more preferably, have a molecular weight of at least about 50,000, and a relatively high acid content in order to increase viscosity in the binder solution, and act as an efficient latent acid catalyst. The preferred catalyst/crosslinking additive should be applicable for a wide range of water-borne coatings of this invention. They can be of the acrylic copolymer emulsion in water variety. The catalyst/crosslinking additive should provide for increased cure kinetics of the urea-formaldehyde resin ultimately and higher crosslinking that results in faster achievement of properties. While generally added in an amount of 0.5-4 wt. % of solids, the preferred concentration is about 1-3.5 wt. %. One known additive that is preferred in this composition is ammonia-neutralized carboxylated acrylate copolymer (preferably ethyl acrylate, butyl acrylate and methacrylic acid), known commercially as Viscolex HB-30, formally from CIBA Specialty Chemicals, now BASF.

Following application of the binder, the glass fiber mat is de-watered under vacuum to remove excess binder solution. The mat is then dried and the binder composition is cured in an oven at elevated temperatures, generally at a temperature of at least about 200° C., for a time sufficient to cure the resin. Heat treatment alone is usually sufficient to effect curing. Catalytic curing may also be used, such as a latent acid catalyst, described above.

The finished glass mat product generally consists of about 80 to about 88 wt. % glass fibers, and about 12 to about 20 wt. % of binder, 15-18 wt. % of binder being most preferred. The following examples are intended to illustrate, without limiting the scope of the claimed invention.

### EXAMPLES

### General Binder Preparation

A container equipped with an air-power stirrer was charged with the appropriate amount of water as detailed in Table 1. After the stirrer was started the latex(es) were added and mixing maintained until homogeneous. Ammonium hydroxide was added until a pH of 7.5-8.5 was achieved. Stirring was continued for another 10 minutes or until the viscosity reached a maximum. The UF resin was added and stirring continued for another 10 minutes or until ready for use.

TABLE 1
Binder Compositions - values are in grams

| | Examples | | | | | |
|---|---|---|---|---|---|---|
| Component | A | B | C | D | E | F |
| GP39 | 333.3 | 326.7 | 246.7 | 216.7 | 163.3 | 166.7 |
| Omnabond XL3460 | 0.0 | 0.0 | 117.1 | 156.1 | 239.0 | 0.0 |
| Omnabond 2579 | 0.0 | 0.0 | 0.0 | 0.0 | 0.0 | 200.0 |
| Viscalex HV30 | 0.0 | 13.3 | 13.3 | 13.3 | 13.3 | 0.0 |
| Water | 667.7 | 660.0 | 622.9 | 613.9 | 584.4 | 633.3 |

### Procedure for Measuring Thermal Mechanical Properties

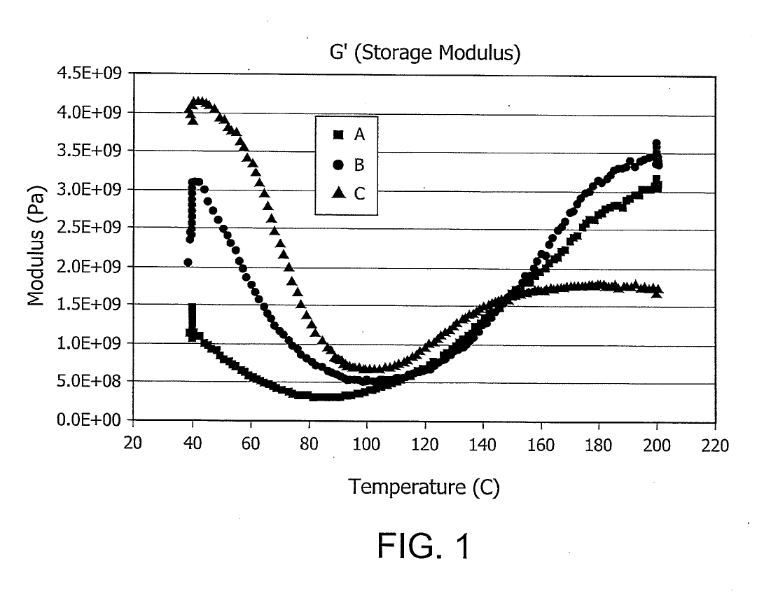

The glass mats of Examples A-F were tested for their tensile strength under dry conditions (Dry tensile) in accordance with standard TAPPI procedures (see, for example, TAPPI T1009om092 or ARMA 4-82) using mat specimens of 2.5 inches×4.5 inches in the machine directions in the machine direction (MD). The results of this test are shown in FIG. 1.

### Procedure for Making Glass Mat Hand Sheets

A 30 gallon mixing tank fitted with a mechanical stirrer was filled with 110 L of 100° F. water. The stirrer was set to 1800 rpm and 4.70 g of polyacrylamide thickener (for example, those produced under the brand names OPTIMER 9901 or NALCO) was added and allowed to completely disperse for 1-1.5 hrs. To the thickened solution 94.1 g of SHERCOPOL DS 140 ethoxylated alkyl amine anionic surfactant (by LUBRIZOL) was added with stirring and allowed to completely disperse for 1 hour. Nine liters of the resulting white water solution was then pumped to a 10 gallon stainless steel mixing tank with 4 internal flanges and conical bottom fitted with a mechanical stirrer equipped with a stainless steel impeller designed for fiber dispersion. The stirrer was set to 1800 rpm and 7.64 g of 13/8″ chopped glass M fiber (for example, those produced by OWENS CORNING, Johns Manville, or PPG) was added and dispersed for 5 minutes. A ball valve at the bottom of the tank was then opened and the slurry was poured into a 12″ times 12″ stainless steel Williams Sheet mold with 1 inch of standing water on the bottom over a removable porous nylon mat. The valve on the sheet mold was then opened and the slurry allowed to drain. The nylon mat covered with the wet fiber mat was then removed from the sheet mold and added the excess white water was removed via a vacuum table fitted with a vacuum slit over which the mat was pulled via a motor and chain. The appropriate binder was evenly applied to the chopped fiber mat and the excess was removed using a vacuum table. The uncured mat was placed on a stainless steel wire mesh frame and cured via forced air from the top direction using a Mini-Dryer R-3 textile oven manufactured by Gate Vaduz AG. The sample was cured for 3 minutes at 180° C. The desired binder add-on or LOI (Loss On Ignition) was adjusted by either diluting the binder and/or adjusting the vacuum.

The glass mats of Examples A-F were tested for their tensile strength under dry conditions (dry tensile) in accordance with GMFT-08 test using mat specimens of 2.5 inches×4.5 inches in the machine direction (MD). The results given in the Tables below are given in lbs per 2.5 inch width.

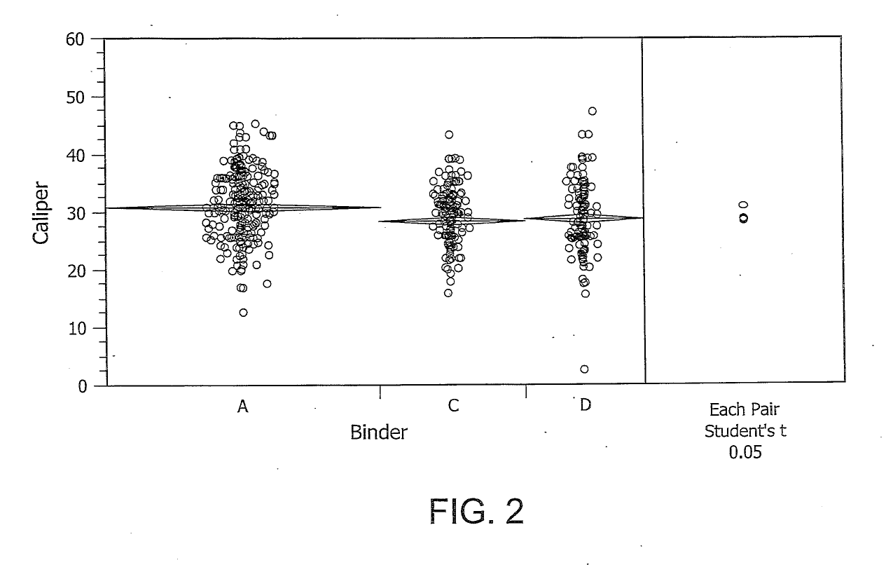

TABLE 2
Mean Caliper v. Binder Chemistry from FIG. 2

| Level | Number | Mean |
|---|---|---|
| A | 491 | 31.0733 |
| C | 264 | 28.6486 |
| D | 216 | 28.9767 |

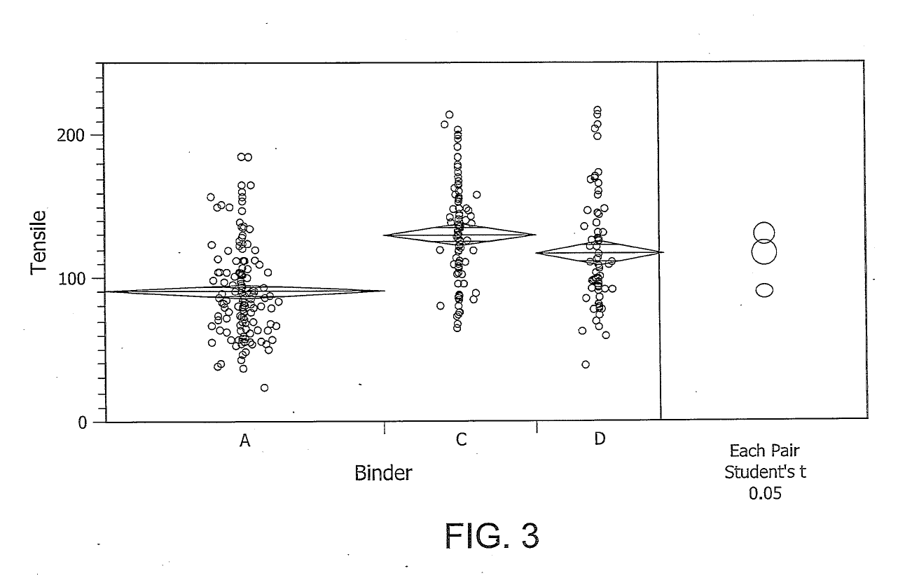

TABLE 3
Mean Tensile (lbs) v. Binder Chemistry from FIG. 3

| Level | Number | Mean |
|---|---|---|
| A | 159 | 91.181 |
| C | 88 | 131.176 |
| D | 72 | 117.888 |

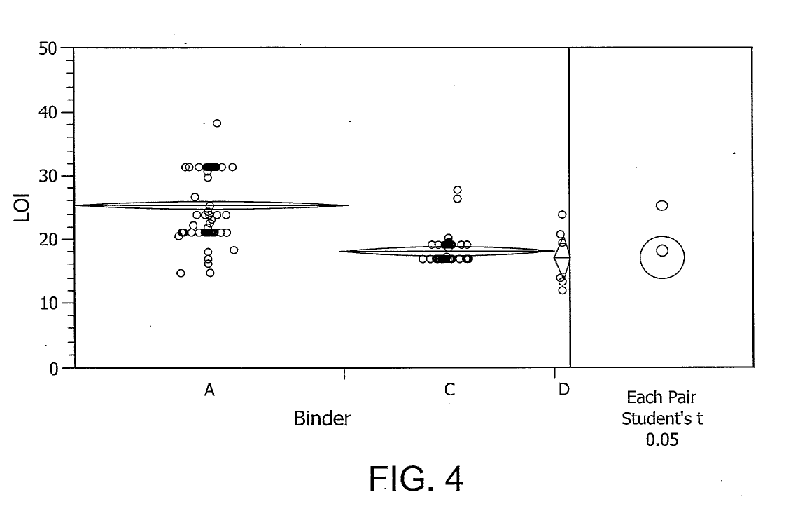

TABLE 4
Mean LOI v. Binder Chemistry from FIG. 4

| Level | Number | Mean |
|---|---|---|
| A | 101 | 25.4248 |
| C | 79 | 18.3198 |
| D | 6 | 17.1674 |

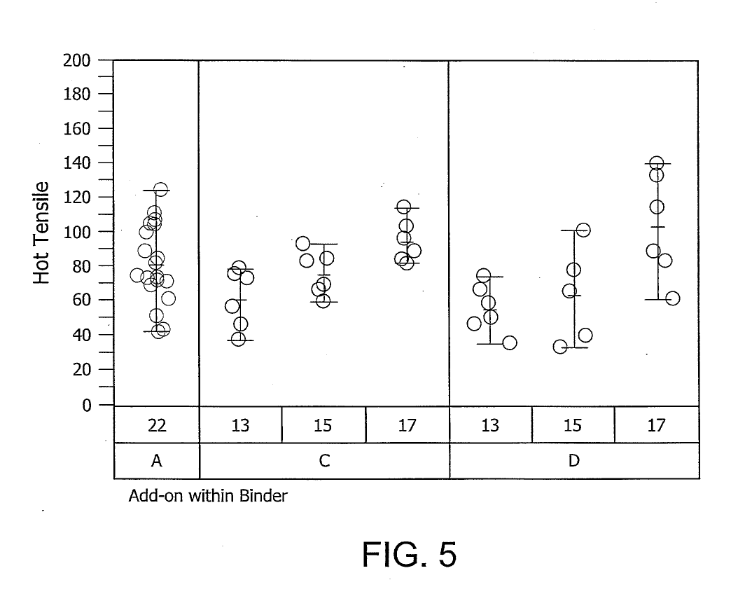

TABLE 5
Mean Tensile (psi) v. Binder Chemistry from FIG. 5

| Level | Number | Mean |
|---|---|---|
| A | 159 | 1214.83 |
| C | 84 | 1780.98 |
| D | 72 | 1661.19 |

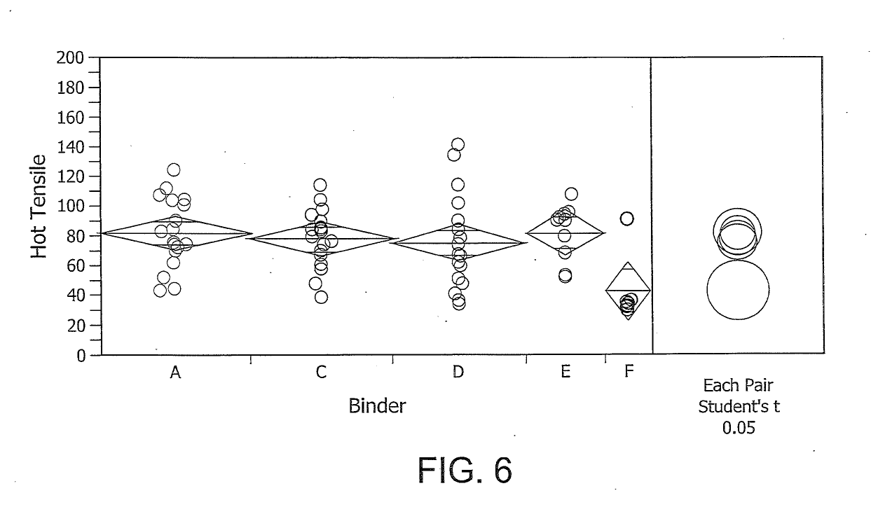

TABLE 6
Mean Hot Tensile (lbs) v. Binder Chemistry from FIG. 6

| Level | Number | Mean |
|---|---|---|
| A | 19 | 81.8421 |
| C | 18 | 78.5556 |
| D | 17 | 75.7647 |
| E | 10 | 82.6000 |
| F | 6 | 43.3333 |

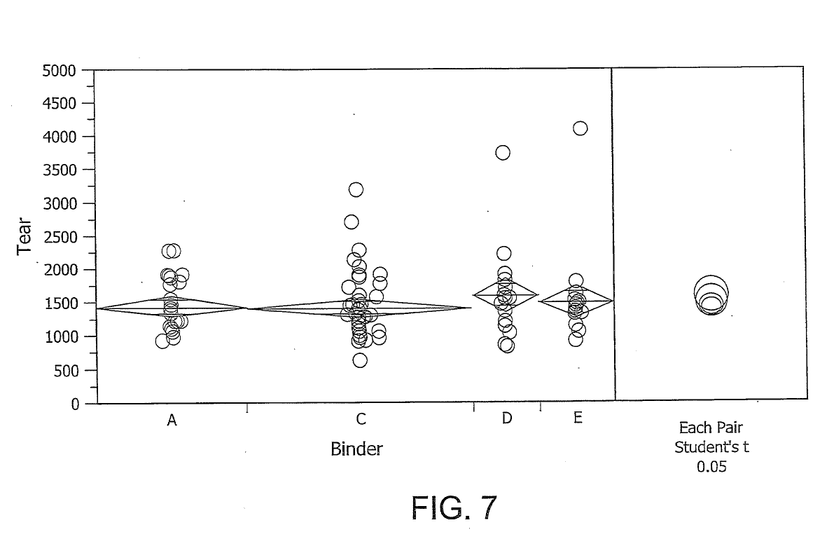

TABLE 7
Mean Tear Strength (psi) v. Binder Chemistry from FIG. 7

| Level | Number | Mean |
|---|---|---|
| A | 36 | 1442.00 |
| C | 54 | 1425.98 |
| D | 16 | 1606.00 |
| E | 18 | 1509.94 |

### Asphalt Shingle Making and Testing Procedure

A metal container is charged with asphalt (400 grams) and preheated in a convection oven set at 375-390° F. Once the asphalt reaches the desired viscosity (flows like water before skinning on surface), wrap the container with fiber glass insulation and continue to heat using a hot plate pre-set for a temperature of 400° F. Lower a thermometer and air powered mixer into the asphalt and start agitation. Add portion-wise 375-390° F. pre-heated dolomite (1000 grams) while stirring. Maintain a temperature of 380-400° F. until a homogeneous and air bubble-free mixture is obtained before applying to the glass mat.

A layer of the asphalt mixture is applied to the glass mat using a bench top hot melt coater/laminator available from ChemInstruments Inc. Model number HLCL-1000 510 Commercial Drive, Fairfield Ohio USA). Once the first or top coat has been applied, and the asphalt coated mat has cooled, the mats are turned over and another layer of asphalt is applied to the uncoated side in the same manner. Final asphalt coated glass mat thickness should be approximately 60 mils.

### Observations

FIG. 1 shows that binder B (containing UF and Viscalex) cures faster and reaches modulus faster than A (UF only). This has implications for achieving higher cross link density and higher strengths. Binder C (containing UF, XL3460, and Viscalex) also cures faster than A (UF only). Binder C reaches a consistent and more stable modulus than either A or B. This implies that binder C is less sensitive to the cure temperatures in the oven. Binder C also shows a lower modulus than either A or B, and implies more flexibility.

FIG. 2 shows the caliper reduction resulting from the new binder at various latex:UF ratios of binder chemistry. Please note that this is handsheet data—production data which is available for only A and E.

FIG. 3 shows the dry tensile strength of the various UF:latex ratios of the new chemistry and how these are higher than control (A).

FIG. 4 shows the LOI data for binders and handsheets of FIGS. 2 and 3.

FIG. 5 shows how hot tensile strength is affected by LOI (middle row) of new binders—as LOI increases, so does hot tensile strength.

FIG. 6 shows hot tensile strength of UF binder and various UF:latex ratios of the new binder. It also shows how a UF and non-carboxylated latex (Omnova 2579), without the latent acid crosslinking agent, results in lower hot tensile strength.

FIG. 7 shows the tear properties for the various UF:latex ratios of the new binder are equivalent to the standard UF binder, but at a lower LOI and caliper.

Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed:

1. A cured non-woven fiber mat comprising randomly disposed fibers bound together with a resinous adhesive, said mat having a caliper of less than about 30 mil, an LOI of less than 18 wt. %, a hot tensile strength of at least about 60 lbs for a sample width of 2.5 inches, and an areal weight of less than about 1.8 lbs/100 ft².

2. A cured non-woven fiber mat comprising randomly disposed fibers bound together with a resinous adhesive having a storage modulus plateau of about 155-165° C.

3. A cured non-woven fiber mat comprising, by weight: from 80 to about 88 wt. % fibers fixedly bounded with a binder comprising about 12 to about 20 wt. % of a urea-formaldehyde based binder, said binder containing on a solids basis: about 50 to about 75 wt. % urea-formaldehyde resin; about 25 to about 50 wt. % of rubber; and about 0.05 to about 4 wt. % of a high molecular weight latent acid crosslinking additive.

4. The fiber mat of claim 3 wherein said fibers comprise glass fibers.

5. The fiber mat of claim 3 wherein said rubber comprises an ammonium-neutralized carboxylated natural or synthetic rubber.

6. The fiber mat of claim 3 wherein said high molecular weight latent acid crosslinking additive comprises an ammonium-neutralized carboxylated polymer.

7. The fiber mat of claim 5 wherein said synthetic rubber comprises: styrene butadiene-acrylic acid terpolymer.

8. The fiber mat of claim 5 wherein said high molecular weight latent acid crosslinking additive comprises ethyl acrylate, butyl acrylate, methacrylate, or a combination thereof.

9. The fiber mat of claim 2 wherein said fibers comprise chopped glass fibers, and said resinous adhesive comprises a urea-formaldehyde based binder containing rubber and a high molecular weight latent acid crosslinking additive.

10. An asphalt coated roofing material comprising a cured non-woven fiber mat comprising, by weight:
from about 60 to about 95 wt. % fibers fixedly bonded with a binder comprising about 5 to about 40 wt. % of a formaldehyde type binder, said binder comprising on a solids basis ratio:
about 50 to about 75 wt. % urea-formaldehyde (UF) resin;
about 25 to about 50 wt. % carboxylated styrene butadiene; and
about 0.05 to about 4 wt. % of a high molecular weight latent acid crosslinking additive.

11. The roofing material of claim 10 wherein said non-woven fiber mat is a chopped glass mat.

12. The roofing material of claim 10 wherein said styrene butadiene copolymer comprises a carboxylated styrene butadiene rubber.

13. The roofing material of claim 10 wherein said high molecular weight latent acid crosslinking additive comprises a latent acid catalyst comprising a high molecular weight, neutralized, carboxylated acrylate copolymer.

14. A process for making a cured non-woven fiber mat comprising:
a) preparing an aqueous slurry of fibers and removing excess water from said slurry to form a non-woven fibrous web;
b) applying a wet binder to said non-woven fibrous web, said binder comprising by weight on a solids basis:
about 50 to about 75 wt. % urea-formaldehyde (UF) resin;
about 25 to about 50 wt. % rubber; and
about 0.05 to about 4 wt. % of a high molecular weight latent acid crosslinking additive; and
c) drying or curing said fibrous web.

15. The process of claim 14 wherein said binder is applied by spraying said binder on said fibrous web to form an uncured binder-coated fibrous web.

16. The process of claim 15 wherein said uncured binder-coated fibrous web is cured by heating.

17. The process of claim 14 wherein said rubber comprises styrene butadiene-acrylic acid terpolymer.

18. The process of claim 14 wherein said rubber comprises carboxylated styrene butadiene rubber (XSBR).

19. An asphalt shingle comprising a glass fiber mat coated with an asphalt composition, said glass fiber mat comprising a cured non-woven fiber mat comprising, by weight:
from about 60 to about 95 wt. % fibers fixedly bonded with a binder comprising about 5 to about 40 wt. % of a formaldehyde type binder, said binder containing on a solids basis:
about 50 to about 75 wt. % urea-formaldehyde (UF) resin;
about 25 to about 50 wt. % rubber; and
about 0.05 to about 4 wt. % of a high molecular weight latent acid crosslinking additive.

20. The shingle of claim 19 wherein said asphalt composition impregnates a plurality of interstices between the fibers in the mat.

21. The shingle of claim 19 wherein said fibers comprise glass fibers.

22. The shingle of claim 19 wherein said mat has a lower storage modulus than an equivalent mat made with a resin containing 100 wt. % UF resin.

23. The shingle of claim 19 wherein said binder comprises synthetic rubber.

24. The shingle of claim 23 wherein said synthetic rubber comprises carboxylated styrene-butadiene rubber (XSBR).

25. The shingle of claim 23 wherein said synthetic rubber comprises: styrene butadiene-acrylic acid terpolymer.

26. An asphalt coated roofing material, comprising:
a mat including randomly disposed fibers bound together with a resinous adhesive, said mat having a caliper of less than about 30 mil, a loss on ignition (LOI) of less than 18 wt. %, a hot tensile strength of at least about 60 lbs for a sample width of 2.5 inches, and an areal weight of less than about 1.8 lbs/100 ft²;
an asphalt coating applied to the mat, said asphalt coating impregnating the mat with an asphalt composition; and
a protective coating of granules applied to at least one surface of the asphalt-coated mat.

27. A process for making a cured non-woven fiber mat comprising:
a) preparing an aqueous slurry of fibers and removing excess water from said slurry to form a non-woven fibrous web;
b) applying a wet binder to said non-woven fibrous web, said binder comprising urea-formaldehyde (UF) resin, rubber; and one or more polymer additives; and
c) drying or curing said fibrous web to form a non-woven mat comprising randomly disposed fibers bound together by said binder, said mat having a caliper of less than about 30 mil, an LOT of less than 18 wt. %, a hot tensile strength of at least about 60 lbs for a sample width of 2.5 inches, and an areal weight of less than about 1.8 lbs/100 ft².

28. The process of claim 27 wherein said rubber comprises: styrene butadiene-acrylic acid terpolymer.

29. A resinous binder for fibrous mats comprising on a solids basis:
about 50 to about 75 wt. % urea-formaldehyde (UF) resin;
about 25 to about 50 wt. % carboxylated styrene-butadiene rubber; and
about 0.05 to about 4 wt. % of a polymer additive comprising a latent polymeric cross-linking agent, a polymer viscosity modifying agent, or both.

30. The resinous binder of claim 29 wherein said carboxylated styrene-butadiene rubber comprises a styrene butadiene-acrylic acid terpolymer.

31. The resinous binder of claim 29 wherein said polymer additive comprises a latent polymeric crosslinking agent comprises a carboxylated acrylate copolymer having a molecular weight of at least about 50,000.
